(19) United States
(12) Patent Application Publication
(10) Pub. No.: US 2024/0054982 A1
(43) Pub. Date: Feb. 15, 2024

(54) SYSTEM AND METHOD FOR ANALYZING AUDIO SIGNALS

(71) Applicant: Game Design World Inc., Columbs, OH (US)

(72) Inventor: James Spencer, Columbus, OH (US)

(73) Assignee: Game Design World Inc., Columbus, OH (US)

(21) Appl. No.: 17/886,614

(22) Filed: Aug. 12, 2022

(51) Int. Cl. G10H 1/00

(52) U.S. Cl. CPC G10H 1/0008; G10H 1/0041; G10H 2210/061

(57) ABSTRACT

In one aspect, a system and method analyze audio signals. The audio signals are divided into segments, and the segments are analyzed separately to determine an aspect of the segment. A file is saved for each of the analyzed segments with an associate file name, and the file is retrievable.

### TECHNICAL FIELD

The present disclosure relates to the field of analyzing audio signals, such as music.

### BACKGROUND

For decades, musicians have written and created music that has been recorded for later playback. This has been commercially monetized by companies that record music and sell the recordings to consumers. More recently, music has been used in electronic gaming, where the consumer does an action in time with the music in order to score points.

Music has also been widely used in other forms of entertainment such as movies and television shows. Traditionally, movies and television shows obtain music by purchasing existing music or by hiring one or more person to write and create the music.

It is desirable to have a system and method for analyzing existing audio signals, such as songs or music. The analyzed audio signals are then stored for later use.

It is an advantage of the present system and method that a portion of an audio signal can be analyzed and stored so that the portion of the audio signal may later be utilized without reproducing other portions of the audio signal.

### SUMMARY

Recognizing the limitations in the prior art, it is desirable for a system and method for analyzing audio signals that allows for isolation of one or more portion of the audio signal. The isolated portion may include isolating audio signals produced by a single instrument of a group of instruments that are all the same type of instrument.

In some embodiments, a method of analyzing one or more audio signals includes receiving an audio signal that comprises at least one portion of musical composition such as a song. A segment of the audio signal is analyzed to determine a property of the audio segment and the segment is stored in a digital file with an assigned file name. The analyzing and storing steps are repeated for each segment of the digital file until all of the segments have been analyzed.

In some embodiments, a method of analyzing one or more audio signals includes receiving an audio signal that comprises at least one portion of musical composition such as a song. A segment of the audio signal is analyzed to determine a property of the audio segment and the segment is stored in a digital file with an assigned file name. The analyzing and storing steps are repeated for each segment of the digital file until all of the segments have been analyzed.

In at least one embodiment, the audio signal is generated from an instrument. The instrument is one of a woodwind instrument, a brass instrument, or a string instrument. In at least one embodiment the instrument is an acoustic guitar, an electric guitar, or a bass guitar.

In at least one embodiment, receiving the audio signal includes playing at least one instrument and recording sound produced by the at least one instrument.

In at least one embodiment, receiving the audio signal includes providing a recording of song, and isolating an audio signal produced by a single instrument utilized to record the song.

In at least one embodiment, each of the segments comprises a single note or group of notes in chord produced by a single instrument

In at least one embodiment, the analyzed property of each segment includes at least one of an abrupt stop, a slide, a muffled end, or a note length.

In at least one embodiment, a system for analyzing audio signals is contemplated. The system includes a processor, a storage device, and an input device, configured to receive audio signals. The processor is communicatively connected to the storage device and the input device. The processor is configured to divide the audio signal into segments, analyze a first segment of the segments to determine a property of the audio segment, store the first segment in a digital file, repeat the analyzing and storing steps for each segment of the segments until all of the segments have been analyzed and stored. Each segment of the audio signal comprises one or more musical notes. Storing the first segment includes assigning a file name to the stored segment.

In at least one embodiment, the processor is configured to compare the stored segments to each other to determine if any of the stored segments are the same, and remove any a segment that is determined to be the same as another segment.

In at least one embodiment, a method of analyzing audio signals includes receiving at least one audio signal. The audio signal is divided into segments, wherein each segment of the audio signal comprises one or more musical note. A sixteenth note or thirty-second note audio block is analyzed and at least one segment is detected that indicates a predetermined special segment. The special segment is analyzed to determine a property of the special segment and the special segment is stored in a digital file with an assigned file name. The analyzing and storing steps are repeated for all detected special segments of the segments until all of the special segments have been analyzed and stored.

In at least one embodiment, the special segment includes one or more notes that indicates that the special segment is a solo performance of an instrument in a song.

In at least one embodiment, the instrument is a guitar and the special segment is a guitar solo.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 illustrates a flow chart for a method of analyzing an audio signal.

FIG. 2 illustrates a flow chart for a method of analyzing an audio signal.

FIG. 3 illustrate a flowchart for a method of analyzing a special segment of an audio signal.

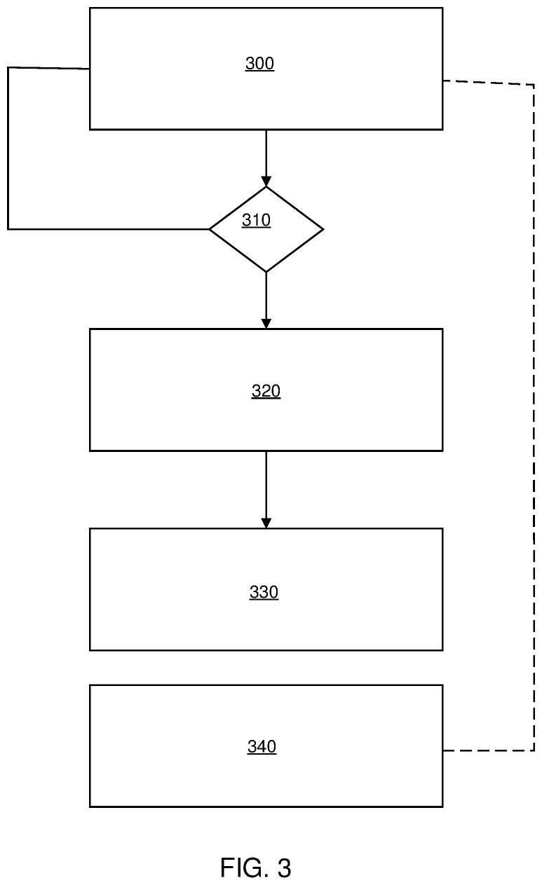

FIG. 4 is a diagram of a system for performing the methods described herein.

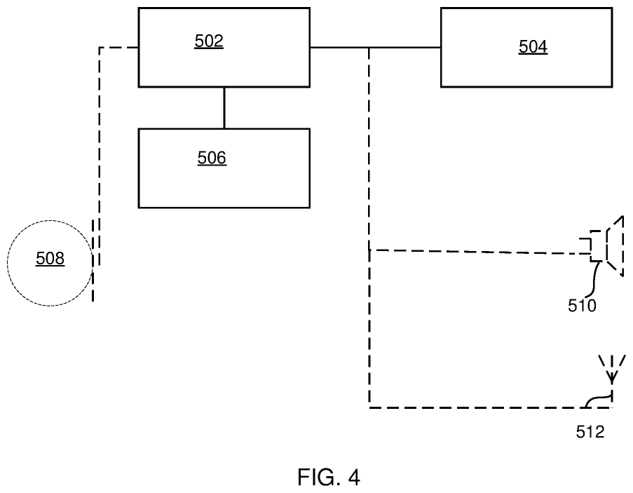

### DETAILED DESCRIPTION

Current music recording systems have complicated and expensive equipment that is used to record individual instruments and then combine the recorded the instruments into a single recording, such as a song or composition. It is extremely difficult to reproduce the sound of a single instrument, or instrument group of a recorded song or composition.

Embodiments of the present system and method are directed to analyzing recorded songs or composition in a matter that isolates a single instrument or instrument group. The analyzed portion is saved in a digital format, such as a in a file stored on a non-volatile recording medium.

According to some embodiments, an audio signal is produced and recorded. The audio signal is produced by one or more persons using a musical instrument to produce sound. The sound is recorded, by any known method, such as analog recording or digital recording, and saved for future playback. The recorded sound produces an audio signal when played back.

When the audio signal includes sounds produced by multiple instruments, the sounds from each instrument are captured in the recording. Although each sound may occur at a same instance in time, the sounds produced by each individual instrument are often discernable, either by the naked ear or by music processing equipment. The current system and method are used to analyze audio signals so that individual instrument or instruments types may be isolated and analyzed individually.

For example, in modern music, many bands include at least one guitar (either electric or acoustic), a bass or bass guitar, and a drum set. Also, other instruments such as piano or electric keyboards, additional guitars, saxophones, trumpets, trombones, violins, banjos, and many more, may be included. Students of music, and those that wish to perfect an instrument, are often only interested in reproducing the sounds made by a particular instrument. For example, a guitar aficionado may listen to a song trying to learn how to reproduce the lead guitar parts of the song. The current system and method is useful in enabling the sounds produced by individual instruments to be analyzed for learning or future reproduction.

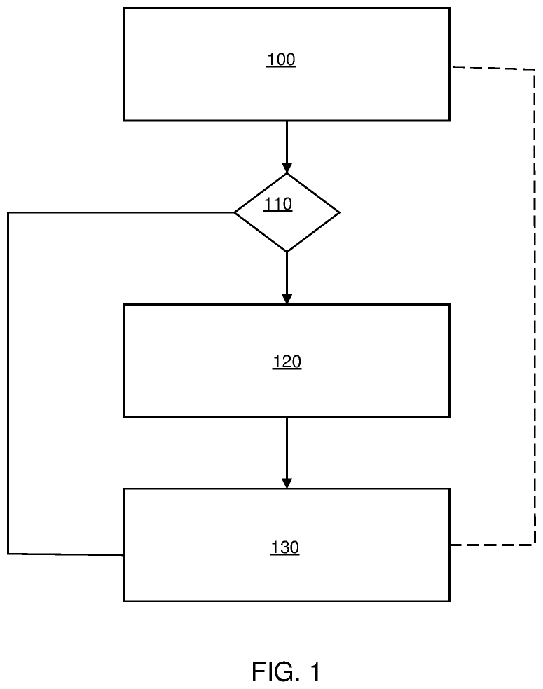

In order to achieve this goal, a system and method are used to analyze an audio signal, the method is illustrated in FIG. 1. The system includes a non-volatile memory and a processor. The processor is configured to take an audio signal and detect particular segments of the signal that were produced by a specific instrument or instrument type. The audio signal is analyzed so that the signals that are caused by the specified instrument are “extracted” from the audio signal (100). (Note, “extracted” does not require that the analyzed portions are actually removed from the signal.) The extracted signal is then analyzed for a predetermined period of time to detect if a predetermined action occurs (110). For example, if the instrument is a guitar than a predetermined action may be an abrupt stop, a muffed note, a slide note, a tap, or other action that may occur. Once a predetermined action is detected, the extracted signal is segmented to produce an audio signal containing only the analyzed segment, the segmented audio signal is assigned a filename, and the segmented audio signal is saved in the non-volatile memory with the associated file name (130). Once the segmented signal is saved, the process is repeated on the next segment of the signal. If a predetermined action is not detected within the predetermined period of time (120), the analyzed portion of the signal is a assigned a filename, and the analyzed portion of the audio signal is saved in the non-volatile memory with the filename (130).

The predetermined time period may be any suitable time period with a minimum length of second and a maximum length of numerous segments. In one exemplary embodiment, the predetermined period of time is six seconds. In another exemplary embodiment, the predetermined period of time is nine seconds. In another exemplary embodiment, the predetermined period of time is twelve seconds.

The method described above may be utilized to analyze audio signals that contain multiple notes produces simultaneously by an instrument or group of like instruments. For example, a guitar player may play a chord which includes multiple notes that are produced simultaneously.

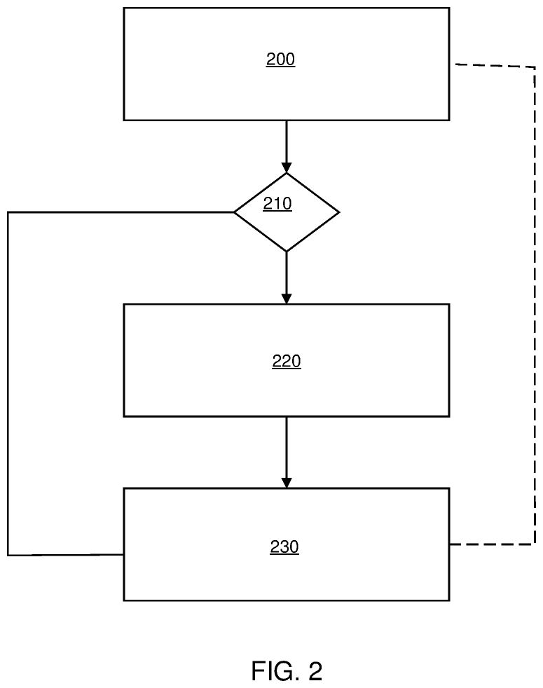

In another embodiment, the system and method include analyzing individual notes. This is illustrated in FIG. 2. The audio signal is analyzed so that signal is “divided” into segments, each segment corresponding to a single note produced by a specified instrument (200). The note is analyzed for a predetermined period of time to see if the note ends and how the note ends (210). For example, with a guitar a note may end with an abrupt stop, a muffed note, a tap, or may extend for more than a predetermined period of time. Once the end of the note is detected and analyzed, the divided segment is assigned a file name and saved in the non-volatile memory with the associate file name (230). If the end of the note is not detected during the predetermined period of time (220), the analyzed segment is saved assigned a file name, and the divided segment is saved with the associated file name (230). The process is repeated for each individual note in the audio signal that correspond to the specified instrument or for the desired segment length of the audio signal.

The predetermined time period may be any suitable time period with a minimum length of second and a maximum length of numerous segments. In one exemplary embodiment, the predetermined period of time is six seconds. In another exemplary embodiment, the predetermined period of time is nine seconds. In another exemplary embodiment, the predetermined period of time is twelve seconds.

The two embodiments described above can be used to analyze the audio signal produced by any stringed instrument, woodwind instrument, or brass instrument. For example, the signal may be produced by any of the following exemplary instruments, a bass, a bass guitar, a saxophone, a trumpet, a baritone, a trombone, an euphonium, a tuba, a French horn, a flute, a piccolo, a bassoon, a violin, a cello, a harp, and a harmonica.

Many modern songs often include a solo, which occurs when only one individual plays during a period of time, or one individual plays a special part while other instruments are used to provide timing or rhythm. Often, but not always, solos are played at a faster tempo than other segments of the song. Many students and fans of music are particularly interested in solos. Therefore, it is desirable to have a system and method that are utilized to specifically analyze solos. The following description will describe a method of analyzing a guitar solo, however, this method is suitable for analyzing a solo produced by any instrument.

An audio signal is analyzed to determine a segment of the audio signal that is produced during a solo (300). Analyzing the signal includes at least one of determining that only a single instrument or type of instrument is playing, determining a change in tempo of the audio signal, or determining an increase in notes produced by a single instrument or type of instrument. The solo segment of the audio signal is divided into segments of notes, such as 16^{th} note segments or 32^{nd} note segments. Each segment is analyzed to determine if a predetermined action occurred to create notes during the segment (310). For example, when the instrument is a guitar, the predetermined action includes one of bends, hammers, pull-offs, or slides. If no predetermined action occurs, the next segment is anlayzed. When a solo segment is detected, the segment is analyzed for a predetermined period of time (320). During the analysis if abrupt stop is detected, the segment is assigned a file name and stored in the memory with the assigned file name (330). During the analysis if an end is detected as a muffed note or action, the segment is assigned a file name and the segment is saved in the memory with the assigned file name (340). If an end is not detected, the segment is set for the predetermined period of time, provided a file name, and the segment is saved with associated file name (340).

The process is repeated for each segment of the solo until the entire solo has been analyzed and each segment is saved with an associated file name. Once the entire solo has been analyzed, the methods described above can be utilized to analyze any additional segments of the audio signal that the user desires.

FIG. 5 illustrates a system configured to perform the methods described above. The system includes a processor (502) connected to a memory (504). The processor may be connected to one or more input devices (506, 508) that are configured to provide audio signals to the processor. The processor (502) may be a CPU or any other processing device. The memory (504) is preferably a non-volatile memory and may be a hard drive, an optical drive, a solid state device, or any other suitable memory device. The processor (502) and the memory device (504) may be connected to one or more output devices (510, 512). One output device (510) is a speaker for converting audio signals into sounds. One output device (512) is a device for transmitting information, such as an antenna. This may include a wire connection or any wireless communication means such as wifi, Bluetooth, or cellular communication.

In an alternative embodiment, the memory (504) may be used to store signals from the input devices (506, 508) and to store information provided by the processor (502).

While the methods described above have been described to analyze the audio signal produced by a single instrument or single type of instrument, the methods may be utilized to analyze the audio signal produced by additional instruments. For example, if the audio signal is a recording of an orchestra playing a piece of music, the audio signal may be analyzed for various instruments. The signal may be analyzed for the audio signal produced by a violin and the audio signal produced by a cello. If the audio signal is a recording of a concert band, the audio signal may be analyzed for a brass instrument, such as tuba, and woodwind instrument such as a saxophone.

Also, although the methods described above describe analyzing the audio signal of a previously recorded audio signal, the method may also be utilized with music being performed live. An audio receiver (508), such as a microphone, can be communicatively connected to the system, and the processor (502) may process the audio signal as it received live. In another embodiment, an audio receiver is communicatively connected to a memory device for storing audio signals, and the audio signals are first stored and then and analyzed by the processer.

In one embodiment, a sound output device, such as a speaker, is communicatively connected to the system and the sound output device is utilized to produce sounds based on saved audio segments.

Of course, the present invention is not limited to the above features and advantages. Those of ordinary skill in the art will recognize additional features and advantages upon reading the following detailed description, and upon viewing the accompanying drawings.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method of analyzing audio signals, the method comprising:
receiving an audio signal, wherein the audio signal comprises at least one portion of a musical composition such as a song;
dividing the audio signal into segments, wherein each segment of the audio signal comprises one or more musical notes;
analyzing a first segment of the segments to determine a property of the audio segment,
storing the first segment in a digital file, wherein storing the first segment includes assigning a file name to the stored segment; and
repeat the analyzing and storing steps for each segment of the segments until all of the segments that are to be analyzed have been analyzed and stored.

2. The method of claim 1, further comprising:
comparing the stored segments to each other to determine if any of the stored segments are the same; and
removing any a segment that is determined to be the same as another segment.

3. The method of claim 1, wherein the audio signal is a signal generated from an instrument.

4. The method of claim 3, wherein the instrument is a string instrument, a woodwind instrument, or a brass instrument.

5. The method of claim 3, wherein the instrument is a guitar.

6. The method of claim 1, wherein receiving the audio signal comprises playing at least one instrument and recording the sound produced by the at least one instrument.

7. The method of claim 1, wherein receiving the audio signal comprises the steps of:
providing a recording of song; and
isolating an audio signal produced by a single instrument utilized to record the song.

8. The method of claim 1, wherein each of the segments comprises a single note or group of notes in chord produced by a single instrument.

9. The method of claim 1, wherein the analyzed property of each segment includes at least one of an abrupt stop, a slide, a muffled end, or a note length.

10. A system for analyzing audio signals, the system comprising:
a processor;
a storage device; and
an input device, configured to receive audio signals;
wherein the processor is communicatively connected to the storage device and the input device;
wherein the processor is configured to:
divide the audio signal into segments, wherein each segment of the audio signal comprises one or more musical notes;
analyze a first segment of the segments to determine a property of the audio segment,
store the first segment in a digital file, wherein storing the first segment includes assigning a file name to the stored segment; and
repeat the analyzing and storing steps for each segment of the segments until all of the segments have been analyzed and stored.

11. The system of claim 10, wherein the processor is configured to:
compare the stored segments to each other to determine if any of the stored segments are the same; and
remove any a segment that is determined to be the same as another segment.

12. The system of claim 10, wherein the audio signal is a signal generated from an instrument.

13. The system of claim 12, wherein the instrument is a string instrument, a woodwind instrument, or a brass instrument.

14. The system of claim 12, wherein the instrument is a guitar.

15. The system of claim 10, wherein receiving the audio signal comprises playing an instrument and recording the sound produced by the instrument.

16. The system of claim 10, wherein receiving the audio signal comprises the steps of:
providing a recording of song; and
isolating an audio signal produced by a single instrument utilized to record the song.

17. The system of claim 10, wherein each of the segments comprises a single note or group of notes in chord produced by a single instrument.

18. The system of claim 10, wherein the analyzed property of each segment includes at least one of an abrupt stop, a slide, a muffled end, or a note length.

19. A method of analyzing audio signals, the method comprising:
receiving at least one audio signal;
dividing the audio signal into segments, wherein each segment of the audio signal comprises one or more musical note;
analyzing sixteenth note or thirty-second note audio block;
detecting at least one segment that indicates a predetermined special segment;
analyzing the special segment to determine a property of the special segment;
storing the special segment in a digital file, wherein storing the special segment includes assigning a file name to the stored segment; and
repeat the analyzing and storing steps for all detected special segments of the segments until all of the special segments have been analyzed and stored.

20. The method of claim 19, wherein the special segment includes one or more notes that indicates that the special segment is a solo performance of an instrument in a song.

21. The method of claim 20, wherein the instrument is a guitar and the special segment is a guitar solo.
